(19) United States
(12) Patent Application Publication
(10) Pub. No.: US 2022/0316569 A1
(43) Pub. Date: Oct. 6, 2022

(54) FLUID COUPLING

(71) Applicant: EXEDY Corporation, Osaka (JP)

(72) Inventors: Kouzou Mori, Osaka (JP); Keisuke Kishihara, Osaka (JP); Tomohiro Tanaka, Osaka (JP); Shota Fukui, Osaka (JP)

(21) Appl. No.: 17/683,805

(22) Filed: Mar. 1, 2022

(30) Foreign Application Priority Data
Apr. 1, 2021 (JP) 2021-062685

(51) Int. Cl. F16H 45/02

(52) U.S. Cl. CPC F16H 45/02; F16H 2045/007

(57) ABSTRACT

A fluid coupling includes a cover, an impeller, a turbine, an output hub, a lock-up piston, and a wall member. The impeller is fixed to the cover. The turbine is disposed opposite to the impeller. The output hub outputs a torque transmitted thereto from the turbine. The lock-up piston is disposed between the cover and the turbine. The lock-up piston is disposed to be axially slidable on the output hub. The lock-up piston is configured to be engaged by friction with the cover. The wall member is attached to the output hub. The wall member defines a hydraulic chamber in cooperation with the lock-up piston.

### CROSS-REFERENCE TO RELATED APPLICATIONS

This application claims priority to Japanese Patent Application No. 2021-062685 filed Apr. 1, 2021. The entire contents of that application are incorporated by reference herein in their entirety.

### TECHNICAL FIELD

The present invention relates to a fluid coupling.

### BACKGROUND ART

A fluid coupling includes an impeller and a turbine and transmits a torque from the impeller to the turbine through hydraulic oil in the interior thereof. The impeller is fixed to a cover to which the torque is inputted. The turbine is disposed opposite to the impeller. When the impeller is rotated, the hydraulic oil flows from the impeller to the turbine. The flow of the hydraulic oil rotates the turbine, whereby the torque is outputted.

Besides, the fluid coupling includes a lock-up device. When the lock-up device is turned on, the torque from the cover is mechanically transmitted to the turbine and is outputted therefrom to an input shaft of a transmission.

For example, a torque converter described in Japan Laid-open Patent Application Publication No. H05-296313 includes a lock-up piston. Efficiency of transmitting power is enhanced by the lock-up piston engaged by friction with a converter cover in a high-speed power transmission range.

In such a fluid coupling including a lock-up piston as described above, it is preferable to enhance responsiveness of the lock-up piston in terms of enhancement in fuel efficiency and so forth. In view of the above, it is an object of the present invention to enhance the responsiveness of the lock-up piston.

### BRIEF SUMMARY

A fluid coupling according to an aspect of the present invention includes a cover, an impeller, a turbine, an output hub, a lock-up piston, and a wall member. The impeller is fixed to the cover. The turbine is disposed opposite to the impeller. The output hub is configured to output a torque transmitted thereto from the turbine. The lock-up piston is disposed between the cover and the turbine. The lock-up piston is disposed to be axially slidable on the output hub. The lock-up piston is configured to be engaged by friction with the cover. The wall member is attached to the output hub. The wall member defines a hydraulic chamber in cooperation with the lock-up piston.

The fluid coupling described above includes the wall member for defining the hydraulic chamber in cooperation with the lock-up piston. It should be noted that hydraulic oil is supplied into the hydraulic chamber through at least one supply pathway. As described above, the hydraulic chamber is formed by the wall member and the lock-up piston; hence, responsiveness of the lock-up piston can be enhanced.

Preferably, the fluid coupling further includes a damper device. The damper device is configured to transmit the torque from the lock-up piston to the output hub therethrough. The damper device includes an input plate, first and second output plates, and an elastic member. The input plate is configured such that the torque is transmitted thereto from the lock-up piston. First and second output plates are disposed to axially interpose the input plate therebetween. The first and second output plates are attached to the output hub. The elastic member elastically couples the input plate and the first and second output plates. At least one of the first and second output plates serves as the wall member.

Preferably, the first output plate is disposed axially between the lock-up piston and the input plate. The second output plate is disposed axially between the turbine and the input plate. The second output plate serves as the wall member.

Preferably, the first output plate includes a first bulging portion axially bulging along a shape of the elastic member. The second output plate includes a second bulging portion axially bulging along the shape of the elastic member. The first bulging portion is axially opened at an apex thereof. In other words, the first bulging portion is provided with a window at the apex thereof. The second bulging portion is axially closed at an apex thereof. In other words, the second bulging portion is not provided with any window at the apex thereof.

Preferably, the first output plate is disposed axially between the lock-up piston and the input plate. The second output plate is disposed axially between the turbine and the input plate. The first output plate serves as the wall member.

Preferably, the first output plate includes the first bulging portion axially bulging along the shape of the elastic member. The second output plate includes the second bulging portion axially bulging along the shape of the elastic member. The first bulging portion is axially closed at the apex thereof. In other words, the first bulging portion is not provided with any window at the apex thereof. The second bulging portion is axially opened at the apex thereof. In other words, the second bulging portion is provided with a window at the apex thereof.

Preferably, the lock-up piston includes a disc portion and a cylindrical portion axially extending from an outer peripheral end of the disc portion. The wall member extends from the output hub to the cylindrical portion.

Overall, according to the present invention, the responsiveness of the lock-up piston can be enhanced.

### BRIEF DESCRIPTION OF THE DRAWINGS

FIG. 1 is a cross-sectional view of a torque converter.

FIG. 2 is a cross-sectional view of a damper device.

FIG. 3 is a front view of a second output plate.

FIG. 4 is a cross-sectional view of a damper device according to a modification.

### DETAILED DESCRIPTION

### [Entire Configuration]

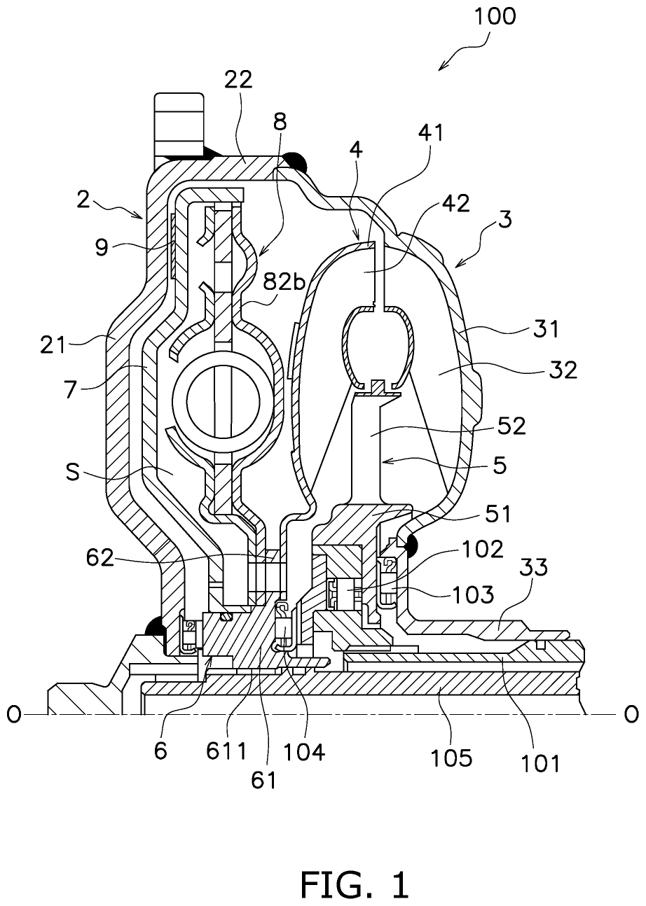

FIG. 1 is a cross-sectional view of a torque converter 100 (exemplary fluid coupling) according to the present embodiment. In the following explanation, the term “axial direction” means an extending direction of a rotational axis O of the torque converter 100. On the other hand, the term “radial direction” means a radial direction of an imaginary circle about the rotational axis O, whereas the term “circumferential direction” means a circumferential direction of the imaginary circle about the rotational axis O. It should be noted that an engine is disposed on the left side in FIG. 1, whereas a transmission is disposed on the right side in FIG. 1, although the engine and the transmission are not shown in FIG. 1.

The torque converter 100 is rotatable about the rotational axis O. The torque converter 100 includes a cover 2, an impeller 3, a turbine 4, a stator 5, an output hub 6, a lock-up piston 7, and a damper device 8.

### [Cover 2]

The cover 2 is a member to which a torque is inputted from the engine. The cover 2 includes a disc portion 21 and a first cylindrical portion 22. The first cylindrical portion 22 axially extends from the outer peripheral end of the disc portion 21 toward the impeller 3.

### [Impeller 3]

The impeller 3 is fixed to the cover 2. The impeller 3 includes an impeller shell 31, a plurality of impeller blades 32, and an impeller hub 33. The impeller shell 31 is fixed to the cover 2 by, for instance, welding.

The impeller blades 32 are fixed to the inner surface of the impeller shell 31. The impeller hub 33 is fixed to the inner peripheral end of the impeller shell 31 by welding or so forth.

### [Turbine 4]

The turbine 4 is disposed opposite to the impeller 3. The turbine 4 includes a turbine shell 41 and a plurality of turbine blades 42. The turbine blades 42 are fixed to the inner surface of the turbine shell 41 by brazing or so forth.

### [Stator 5]

The stator 5 is configured to regulate the flow of hydraulic oil returning from the turbine 4 to the impeller 3. The stator 5 is rotatable about the rotational axis O. When described in detail, the stator 5 is supported by a stationary shaft 101, which is non-rotatable, through a one-way clutch 102. The stator 5 is disposed between the impeller 3 and the turbine 4.

The stator 5 includes a stator carrier 51 having a disc shape and a plurality of stator blades 52 attached to the outer peripheral surface of the stator carrier 51. It should be noted that a first thrust bearing 103 is disposed between the stator 5 and the impeller 3, whereas a second thrust bearing 104 is disposed between the stator 5 and the output hub 6.

### [Output Hub]

The output hub 6 is configured to output the torque, transmitted thereto from the turbine 4, to an input shaft 105 of the transmission. The turbine 4 is attached to the output hub 6. When described in detail, the turbine shell 41 is attached to the output hub 6 through at least one rivet or so forth. The output hub 6 is provided with a spline hole 611. The input shaft 105 is spline-coupled to the spline hole 611.

The output hub 6 includes a boss portion 61 and a flange portion 62. The boss portion 61 has a cylindrical shape and extends in the axial direction. The boss portion 61 is provided with the spline hole 611. The flange portion 62 extends radially outward from the outer peripheral surface of the boss portion 61. The flange portion 62 has an annular shape and extends in the circumferential direction. The turbine shell 41 is attached to the flange portion 62.

### [Lock-Up Piston]

The lock-up piston 7 is disposed between the cover 2 and the turbine 4 so as to be axially movable. When described in detail, the lock-up piston 7 is disposed to be axially slidable on the output hub 6. In more detail, the lock-up piston 7 is disposed to be axially slidable on the outer peripheral surface of the boss portion 61 of the output hub 6. Besides, the lock-up piston 7 is rotatable relative to the output hub 6.

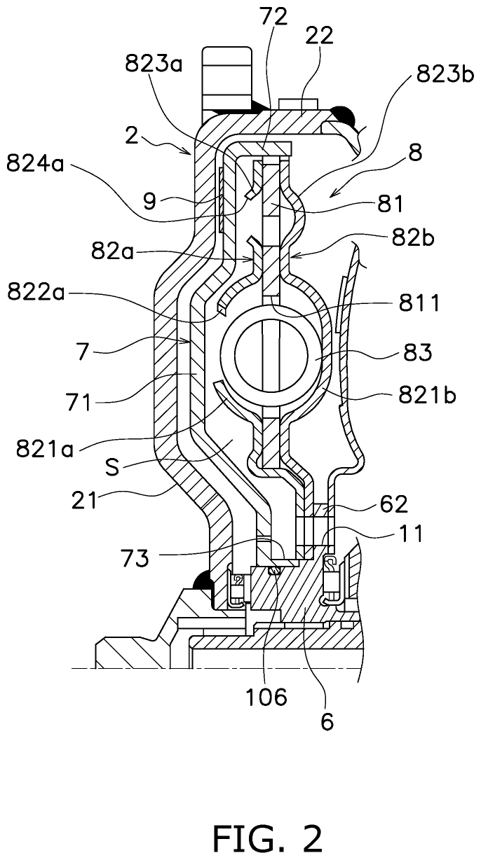

As shown in FIG. 2, the lock-up piston 7 is configured to be engaged by friction with the cover 2. When described in detail, the lock-up piston 7 is configured to be engaged by friction at the outer peripheral end thereof with the cover 2. It should be noted that in a condition shown in FIG. 2, the lock-up piston 7 is not being engaged by friction with the cover 2. When moved leftward from the condition shown in FIG. 2, the lock-up piston 7 is engaged by friction with the cover 2. The lock-up piston 7 includes a disc portion 71, a second cylindrical portion 72 (exemplary cylindrical portion), and a slide portion 73.

The disc portion 71 is provided with a friction member 9 fixed to the outer peripheral end thereof. The disc portion 71 is configured to press the disc portion 21 of the cover 2 through the friction member 9. When the disc portion 71 thus presses the cover 2 through the friction member 9, the lock-up piston 7 is engaged by friction with the cover 2. It should be noted that the friction member 9 may be fixed not to the lock-up piston 7 but to the cover 2. The friction member 9 has an annular shape.

The second cylindrical portion 72 extends from the outer peripheral end of the disc portion 71 in the axial direction. The second cylindrical portion 72 extends in a direction remote from the cover 2. The outer peripheral surface of the second cylindrical portion 72 is disposed at an interval from the inner peripheral surface of the first cylindrical portion 22 of the cover 2.

The slide portion 73 has a cylindrical shape. The slide portion 73 extends from the inner peripheral end of the disc portion 71 in the axial direction. The slide portion 73 extends in the direction remote from the cover 2. The slide portion 73 is supported by the output hub 6 so as to be slidable on the outer peripheral surface of the output hub 6. The outer peripheral surface of the output hub 6 is provided with a seal member 106. The seal member 106 seals between the inner peripheral surface of the slide portion 73 of the lock-up piston 7 and the outer peripheral surface of the output hub 6.

### [Damper Device]

The damper device 8 is disposed axially between the lock-up piston 7 and the turbine 4. The damper device 8 is configured to transmit the torque from the lock-up piston 7 to the output hub 6. The damper device 8 elastically couples the lock-up piston 7 and the output hub 6. The damper device 8 includes an input plate 81, a first output plate 82a, a second output plate 82b, a plurality of first torsion springs 83 (exemplary elastic members), and a plurality of second torsion springs (not shown in the drawings).

### [Input Plate]

The input plate 81 is configured such that the torque is transmitted thereto from the lock-up piston 7. The input plate 81 has a disc shape. The input plate 81 is attached at the outer peripheral end thereof to the lock-up piston 7. The input plate 81 is rotated unitarily with the lock-up piston 7. It should be noted that the input plate 81 is axially movable relative to the lock-up piston 7.

When described in detail, the input plate 81 is provided with a plurality of teeth on the outer peripheral end thereof. The teeth of the input plate 81 are engaged with axially extending grooves provided on the second cylindrical portion 72 of the lock-up piston 7.

The input plate 81 includes first holes 811 extending in the circumferential direction. The first holes 811 accommodate the first torsion springs 83. Besides, the input plate 81 includes second holes (not shown in the drawings) extending in the circumferential direction. The second holes accommodate the second torsion springs. The second holes are disposed radially outside the first hole 811.

### [First and Second Output Plates]

The first and second output plates 82a and 82b are disposed such that the input plate 81 is axially interposed therebetween. In other words, the input plate 81 is disposed axially between the first and second output plates 82a and 82b. The first and second output plates 82a and 82b are rotatable relative to the input plate 81. The first and second output plates 82a and 82b are unitarily rotated with each other.

The first output plate 82a is disposed axially between the lock-up piston 7 and the input plate 81. The second output plate 82b is disposed axially between the turbine 4 and the input plate 81. In other words, the lock-up piston 7, the first output plate 82a, the input plate 81, and the second output plate 82b are sequentially disposed in this order in the axial direction.

The first and second output plates 82a and 82b are attached to the output hub 6. For example, the first and second output plates 82a and 82b are fixed at the inner peripheral ends thereof to the flange portion 62 of the output hub 6 by at least one rivet or so forth.

The first output plate 82a includes a plurality of first bulging portions 821a. The first bulging portions 821a are axially opposed to the first torsion springs 83. The first bulging portions 821a extend in the circumferential direction.

The first bulging portions 821a axially bulge along the shapes of the first torsion springs 83. When described in detail, the first bulging portions 821a bulge toward the lock-up piston 7. Each first bulging portion 821a is axially opened at the apex thereof. In other words, each first bulging portion 821a includes a window 822a.

Besides, the first output plate 82a includes a plurality of third bulging portions 823a. The third bulging portions 823a are disposed radially outside the first bulging portions 821a. The third bulging portions 823a are opposed to the second torsion springs. The third bulging portions 823a extend in the circumferential direction.

The third bulging portions 823a axially bulge along the shapes of the second torsion springs. When described in detail, the third bulging portions 823a bulge toward the lock-up piston 7. In other words, the third bulging portions 823a bulge in the same direction as the first bulging portions 821a. It should be noted that the third bulging portions 823a bulge to a smaller extent than the first bulging portions 821a. Each third bulging portion 823a is axially opened at the apex thereof. In other words, each third bulging portion 823a includes a window 824a.

The second output plate 82b defines a hydraulic chamber S in cooperation with the lock-up piston 7. In other words, the second output plate 82b serves as a wall member.

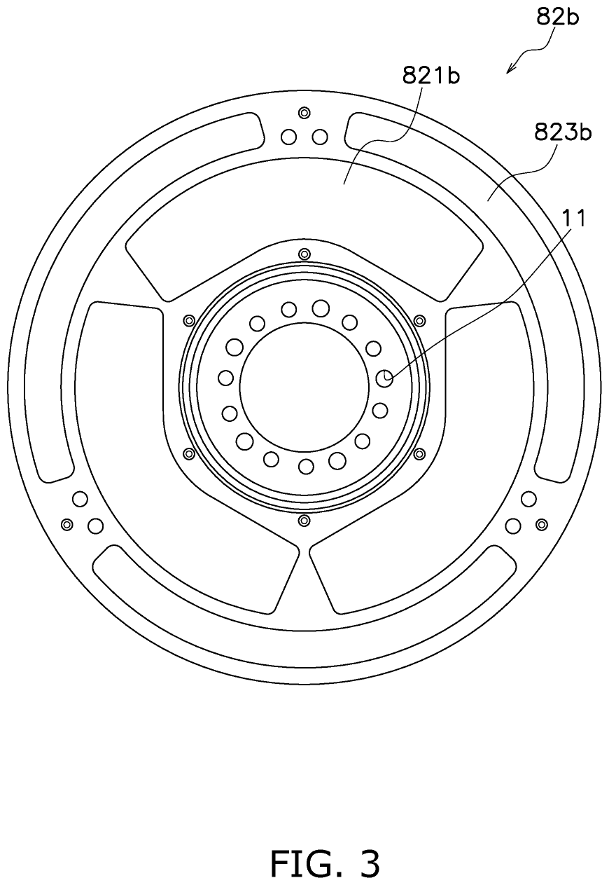

As shown in FIGS. 2 and 3, the second output plate 82b includes a plurality of second bulging portions 821b. The second bulging portions 821b are axially opposed to the first torsion springs 83. The second bulging portions 821b extend in the circumferential direction. The second bulging portions 821b are located in approximately the same radial position as the first bulging portions 821a.

The second bulging portions 821b axially bulge along the shapes of the first torsion springs 83. When described in detail, the second bulging portions 821b bulge toward the turbine 4. Each second bulging portion 821b is axially closed at the apex thereof. In other words, each second bulging portion 821b is not axially opened without being provided with any window.

Besides, the second output plate 82b includes a plurality of fourth bulging portions 823b. The fourth bulging portions 823b are disposed radially outside the second bulging portions 821b. The fourth bulging portions 823b are opposed to the second torsion springs. The fourth bulging portions 823b extend in the circumferential direction.

The fourth bulging portions 823b axially bulge along the shapes of the second torsion springs. When described in detail, the fourth bulging portions 823b bulge toward the turbine 4. In other words, the fourth bulging portions 823b bulge in the same direction as the second bulging portions 821b. It should be noted that the fourth bulging portions 823b bulge to a smaller extent than the second bulging portions 821b. Each fourth bulging portion 823b is axially closed at the apex thereof. In other words, each fourth bulging portion 823b is not axially opened without being provided with any window.

Thus, the second output plate 82b is not provided with any axially opened window. Because of this, the second output plate 82b defines the hydraulic chamber S in cooperation with the lock-up piston 7. In other words, the second output plate 82b serves as the wall member. It should be noted that the second output plate 82b extends from the output hub 6 to the second cylindrical portion 72 of the lock-up piston 7. The outer peripheral surface of the second output plate 82b may or may not be in contact with the inner peripheral surface of the second cylindrical portion 72.

When the outer peripheral surface of the second output plate 82b and the inner peripheral surface of the second cylindrical portion 72 are not in contact with each other, a gap therebetween can be set to be about 1.5 mm or less, and preferably, about 0.5 mm or less.

Besides, the torque converter 100 includes a plurality of supply pathways 11. The supply pathways 11 are configured to supply the hydraulic oil into the hydraulic chamber S formed by the second output plate 82b and the lock-up piston 7.

The supply pathways 11 are through holes each penetrating the turbine shell 41, the flange portion 62, the second output plate 82b, and the first output plate 82a. The supply pathways 11 are disposed apart from each other at intervals in the circumferential direction.

### [Torsion Springs]

As shown in FIG. 2, the first torsion springs 83 elastically couple the input plate 81 and the first and second output plates 82a and 82b. The first torsion springs 83 transmit the torque, outputted from the input plate 81, to the first and second output plates 82a and 82b.

The second torsion springs elastically couple the input plate 81 and the first and second output plates 82a and 82b. The second torsion springs transmit the torque, outputted from the input plate 81, to the first and second output plates 82a and 82b together with the first torsion springs 83. It should be noted that only the first torsion springs 83 are actuated until an angle of torsion between the input plate 81 and the first and second output plates 82a and 82b exceeds a predetermined value, and then, the second torsion springs are also actuated together with the first torsion springs 83 when the angle of torsion exceeds the predetermined value.

### [Action]

Next, the action of the torque converter 100 configured as described above will be explained. In a torque converter actuation range that a torque is transmitted from the impeller 3 to the turbine 4 through the hydraulic oil, the lock-up piston 7 is axially moved to a side remote from the cover 2 and is not engaged by friction with the cover 2. In other words, transmission of the torque is not made by the lock-up piston 7.

Next, when the torque converter 100 satisfies a predetermined condition, the hydraulic oil is supplied to the hydraulic chamber S through the supply pathways 11. Accordingly, the lock-up piston 7 is moved toward the cover 2 and is engaged by friction with the cover 2. As a result, the torque, outputted from the cover 2, is transmitted to the output hub 6 through the lock-up piston 7 and the damper device 8.

### [Modifications]

One preferred embodiment of the present invention has been explained above. However, the present invention is not limited to the above, and a variety of changes can be made without departing from the gist of the present invention.

For example, in the preferred embodiment described above, the second output plate 82b serves as the wall member. However, in the torque converter 100, the configuration of the wall member is not limited to this. When described in detail, the first output plate 82a may serve as the wall member.

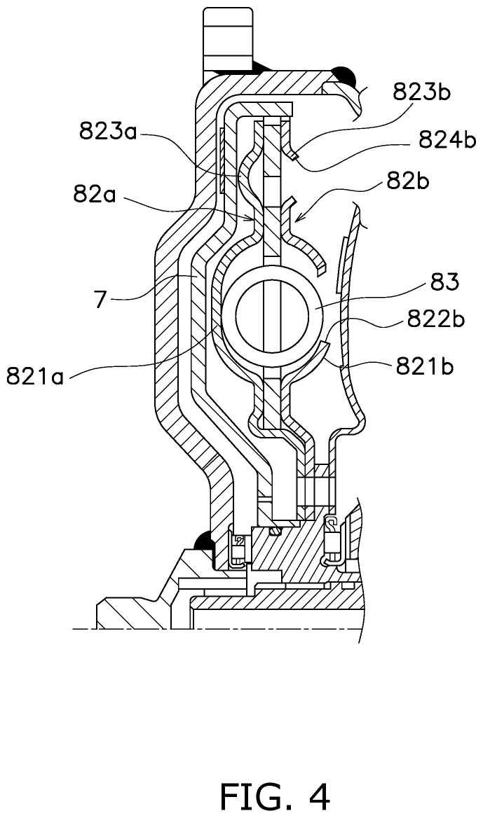

In this case, as shown in FIG. 4, each first bulging portion 821a of the first output plate 82a is axially closed at the apex thereof. In other words, each first bulging portion 821a is not axially opened without being provided with any window. On the other hand, each second bulging portion 821b of the second output plate 82b is axially opened at the apex thereof. In other words, each second bulging portion 821b is provided with a window 822b.

Besides, each third bulging portion 823a of the first output plate 82a is axially closed at the apex thereof. In other words, each third bulging portion 823a is not axially opened without being provided with any window. On the other hand, each fourth bulging portion 823b of the second output plate 82b is axially opened at the apex thereof. In other words, each fourth bulging portion 823b is provided with a window 824b.

It should be noted that both the first and second output plates 82a and 82b may serve as the wall members. In other words, all the first to fourth bulging portions 821a, 821b, 823a, and 823b may be axially closed.

### REFERENCE SIGNS LIST

2: Cover
3: Impeller
4: Turbine
6: Output hub
7: Lock-up piston
71: Disc portion
72: Second cylindrical portion
8: Damper device
81: Input plate
82a: First output plate
821a: First bulging portion
822a: Window
82b: Second output plate
821b: Second bulging portion
822b: Window
83: First torsion spring
100: Torque converter

What is claimed is:

1. A fluid coupling comprising:
a cover;
an impeller fixed to the cover;
a turbine disposed opposite to the impeller;
an output hub configured to output a torque transmitted thereto from the turbine;
a lock-up piston disposed between the cover and the turbine, the lock-up piston disposed to be axially slidable on the output hub, the lock-up piston configured to be engaged by friction with the cover; and
a wall member attached to the output hub, the wall member defining a hydraulic chamber in cooperation with the lock-up piston.

2. The fluid coupling according to claim 1, further comprising:
a damper device configured to transmit the torque from the lock-up piston to the output hub therethrough, wherein
the damper device includes
an input plate configured such that the torque is transmitted thereto from the lock-up piston,
first and second output plates disposed to axially interpose the input plate therebetween, the first and second output plates attached to the output hub, and
an elastic member elastically coupling the input plate and the first and second output plates, and
at least one of the first output plate or the second output plate serves as the wall member.

3. The fluid coupling according to claim 2, wherein
the first output plate is disposed axially between the lock-up piston and the input plate,
the second output plate is disposed axially between the turbine and the input plate, and
the second output plate serves as the wall member.

4. The fluid coupling according to claim 3, wherein
the first output plate includes a first bulging portion axially bulging along a shape of the elastic member,
the second output plate includes a second bulging portion axially bulging along the shape of the elastic member,
the first bulging portion is axially opened at an apex thereof, and
the second bulging portion is axially closed at an apex thereof.

5. The fluid coupling according to claim 2, wherein
the first output plate is disposed axially between the lock-up piston and the input plate,
the second output plate is disposed axially between the turbine and the input plate, and
the first output plate serves as the wall member.

6. The fluid coupling according to claim 5, wherein
the first output plate includes a first bulging portion axially bulging along a shape of the elastic member,
the second output plate includes a second bulging portion axially bulging along the shape of the elastic member,
the first bulging portion is axially closed at an apex thereof, and
the second bulging portion is axially opened at an apex thereof.

7. The fluid coupling according to claim 1, wherein
the lock-up piston includes a disc portion and a cylindrical portion, the cylindrical portion axially extending from an outer peripheral end of the disc portion, and
the wall member extends from the output hub to the cylindrical portion.
